(19) United States
(12) Patent Application Publication
(10) Pub. No.: US 2020/0341923 A1
(43) Pub. Date: Oct. 29, 2020

(54) INFORMATION PROCESSING SYSTEM

(71) Applicant: FUJITSU CLIENT COMPUTING LIMITED, Kanagawa (JP)

(72) Inventors: Yuji Nakayama, Kawasaki (JP); Masatoshi Kimura, Kawasaki (JP)

(73) Assignee: FUJITSU CLIENT COMPUTING LIMITED, Kanagawa (JP)

(21) Appl. No.: 16/817,011

(22) Filed: Mar. 12, 2020

(30) Foreign Application Priority Data
Apr. 23, 2019 (JP) 2019-082243

(51) Int. Cl. G06F 13/40; G06F 16/28

(52) U.S. Cl. CPC G06F 13/4004; G06F 16/285

(57) ABSTRACT

An information processing system includes: a plurality of information processing apparatuses that includes a main information processing apparatus and a plurality of sub information processing apparatuses, each of the plurality of information processing apparatuses being provided with a memory and a hardware processor; and a relay device that relays communication between the plurality of information processing apparatuses connected to each other over a plurality of connectors provided on a bus. In each of the plurality of sub information processing apparatuses, the memory stores connection information representing whether the main information processing apparatus or each of the other sub information processing apparatuses is a communication target of the corresponding sub information processing apparatus in units of the connectors. The hardware processor communicates with at least one of the plurality of information processing apparatuses based on the connection information.

### CROSS-REFERENCE TO RELATED APPLICATIONS

This application is based upon and claims the benefit of priority from Japanese Patent Application No. 2019-082243, filed Apr. 23, 2019, the entire contents of which are incorporated herein by reference.

### FIELD

Embodiments described herein relate generally to an information processing system.

### BACKGROUND

A distributed computer system having a plurality of platforms has been known. The distributed computer system achieves high-speed processing by distributing processing to processing apparatuses, such as platforms.

When the processing apparatuses are caused to execute processing by such a distributed computer system, data is transmitted and received between the processing apparatuses. For this reason, data traffic of the distributed computer system as a whole is enormous.

In a conventional information processing system that implements the distributed computer system, it has been difficult to make data communication between processing apparatuses efficient.

### SUMMARY

An information processing system according to one aspect of the present disclosure includes a plurality of information processing apparatuses and a relay device. The plurality of information processing apparatuses includes a main information processing apparatus and a plurality of sub information processing apparatuses, each of the plurality of information processing apparatuses being provided with a memory and a hardware processor. The relay device is configured to relay communication between the plurality of information processing apparatuses connected to each other over a plurality of connectors provided on a bus. In each of the plurality of sub information processing apparatuses, the memory stores connection information representing whether the main information processing apparatus or each of the other sub information processing apparatuses is a communication target of the corresponding sub information processing apparatus in units of the connectors. The hardware processor communicates with at least one of the plurality of information processing apparatuses based on the connection information.

An information processing system according to another aspect of the present disclosure includes a plurality of information processing apparatuses and a relay device. The plurality of information processing apparatuses includes a main information processing apparatus and a plurality of sub information processing apparatuses, each of the plurality of information processing apparatuses being provided with a memory and a hardware processor. The relay device is configured to relay communication between the plurality of information processing apparatuses connected to each other over a plurality of connectors provided on a bus. The plurality of connectors are classified into connectors belonging to a first segment and connectors belonging to a second segment. The main information processing apparatus is connected to one of the connectors belonging to the first segment and one of the connectors belonging to the second segment. First sub information processing apparatuses among the plurality of sub information processing apparatuses are connected to remaining connectors belonging to the first segment. Second sub information processing apparatuses among the plurality of sub information processing apparatuses are connected to remaining connectors belonging to the second segment. At least one of the plurality of first sub information processing apparatuses includes a first memory and a first hardware processor. The first memory is configured to store connection information representing whether the main information processing apparatus or each of the other plurality of first sub information processing apparatuses is a communication target in units of the connectors. The first hardware processor is configured to communicate with the main information processing apparatus or at least one of the plurality of first sub information processing apparatuses based on the connection information. At least one of the plurality of second sub information processing apparatuses includes a second memory and a second hardware processor. The second memory is configured to store connection information representing whether the main information processing apparatus or each of the other plurality of second sub information processing apparatuses is a communication target in units of the connectors. The second hardware processor is configured to communicate with the main information processing apparatus or at least one of the plurality of second sub information processing apparatuses based on the connection information.

### BRIEF DESCRIPTION OF THE DRAWINGS

FIG. 1 is a diagram schematically illustrating a connection configuration of a plurality of platforms 2 in an information processing system 1 according to the present embodiment;

FIG. 2 is a diagram schematically illustrating a hardware configuration of the platform 2;

FIG. 3 is a diagram illustrating a software configuration of the platform 2;

FIG. 4 is a diagram schematically illustrating a hardware configuration of a PCIe bridge controller 3;

FIG. 5 is a diagram for describing an example of a data transfer method between the platforms 2 through the PCIe bridge controller 3 in the information processing system 1 according to the present embodiment;

FIG. 6 is a block diagram illustrating functions of each platform 2 and the PCIe bridge controller 3;

FIG. 7 is a diagram showing an example of a communication target registration table T2-1 stored in a storage unit 2a-1 of a platform 2-1 connected to a slot #0;

FIG. 8 is a diagram showing an example of a communication target registration table T2-3 stored in a storage unit 2a-3 of a platform 2-3 connected to a slot #2;

FIG. 9 is a diagram illustrating communication targets of the platform 2-1 regulated by the communication target registration table T2-1 shown in FIG. 7;

FIG. 10 is a diagram illustrating communication targets of the platform 2-3 regulated by the communication target registration table T2-3 shown in FIG. 8;

FIG. 11 is a flowchart for describing the flow of communication processing executed between the platform 2-1 and the platform 2-3 according to the communication target registration table T2-1 shown in FIG. 7 and the communication target registration table T2-3 shown in FIG. 8;

FIG. 12 is a diagram schematically illustrating the connection configuration of a plurality of platforms 2 in an information processing system 11 according to the present embodiment;

FIG. 13 is a diagram showing an example of a communication target registration table T2-0 stored in a storage unit 2a-0 of a platform 2-0 connected to the slot #0;

FIG. 14 is a diagram showing an example of the communication target registration table T2-3 stored in the storage unit 2a-3 of the platform 2-3 connected to the slot #2;

FIG. 15 is a diagram illustrating communication targets belonging to a segment α of the platform 2-0 regulated by the communication target registration table T2-0 shown in FIG. 14;

FIG. 16 is a diagram illustrating communication targets belonging to the segment α of the platform 2-3 regulated by the communication target registration table T2-3 shown in FIG. 14;

FIG. 17 is a diagram showing an example of the communication target registration table T2-3 stored in the storage unit 2a-3 of the platform 2-3 connected to the slot #2 in the information processing system 1 illustrated in FIG. 1; and

FIG. 18 is a flowchart for describing the flow of communication processing executed between the platform 2-3 and the platform 2-1 according to the communication target registration table T2-1 shown in FIG. 7 and the communication target registration table T2-3 shown in FIG. 17.

### DETAILED DESCRIPTION

According to the embodiments of the present disclosure, it is possible to improve the efficiency of data communication between processing apparatuses in an information processing system that implements a distributed computer system.

### First Embodiment

Hereinafter, an information processing system according to an embodiment of the present disclosure will be described in detail with reference to the accompanying diagrams.

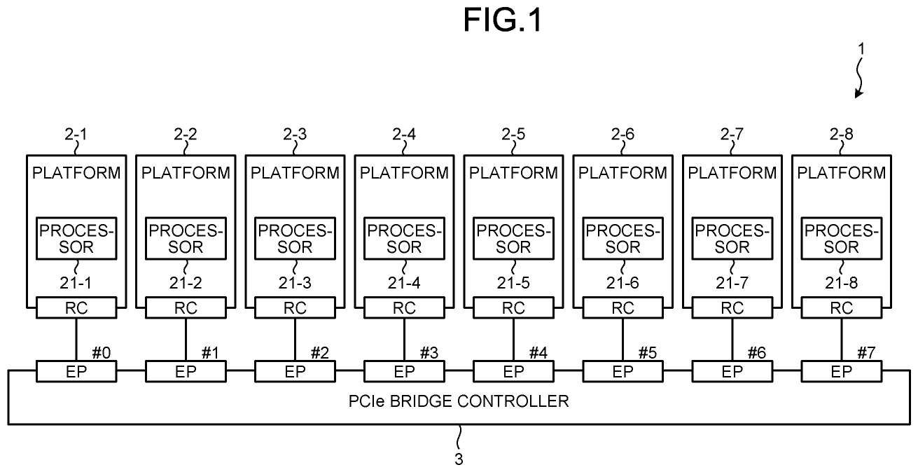

FIG. 1 is a diagram schematically illustrating the connection configuration of a plurality of platforms in an information processing system 1 according to the present embodiment.

### System Configuration

The information processing system 1 illustrated in FIG. 1 includes a peripheral component interconnect express (PCIe; registered trademark) bridge controller 3 and a plurality of (eight in the example illustrated in FIG. 1) platforms 2-1 to 2-8. Each of the platforms 2-1 to 2-8 is connected to the PCIe bridge controller 3.

Hereinafter, as a code representing a platform, codes “2-1” to “2-8” are used when it is necessary to specify each individual platform. When representing an arbitrary platform, a code “2” is used. The platform 2 may be referred to as a PC platform 2.

### Platform

The platform 2-1, as a main information processing apparatus, includes a processor 21-1. Similarly, the platforms 2-2 to 2-8, as sub information processing apparatuses, include processors 21-2 to 21-8, respectively. In the PCIe, while each of the processors 21-1 to 21-8 serves as a root complex (RC) that can operate as a host, a device mounted on the PCIe bridge controller 3 serves as an end point (EP). Then, data transfer between the host and the device is performed.

The processors 21-1 to 21-8 may be provided by different manufacturers (vendors). For example, it is assumed that the processors 21-1, 21-2, 21-3, 21-4, 21-5, 21-6, 21-7, and 21-8 are provided by A company, B company, C company, D company, E company, F company, G company, and H company, respectively.

In addition, different platforms may be connected to the EPs mounted on the PCIe bridge controller 3. In addition, two or more EPs may be connected to one platform, and the platform side may communicate with the PCIe bridge controller 3 using a plurality of RCs.

Hereinafter, as a code representing a processor, reference numerals “21-1” to “21-8” and the like are used when it is necessary to specify one of a plurality of processors, but reference numeral “21” is used when representing an arbitrary processor.

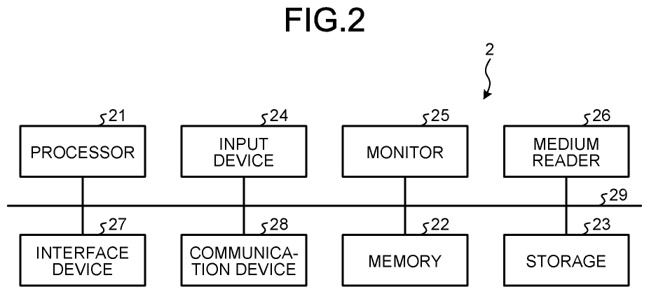

The platforms 2-1 to 2-8 are computer environment for performing arithmetic processing, such as AI processing or image processing. FIG. 2 is a diagram schematically illustrating the hardware configuration of the platform 2 in the information processing system 1.

As illustrated in FIG. 2, the platform 2 has a memory 22 for temporarily storing various kinds of information and a storage 23. In addition, the platform 2 has a processor 21 for executing various kinds of arithmetic processing, an input device 24 for receiving a data input, and a monitor 25. In addition, the platform 2 has a medium reader 26 that reads a program and the like from a storage medium, an interface device 27 for connection with various apparatuses, and a communication device 28 for wired or wireless connection with other information processing apparatuses. Each of the devices 21 to 28 is connected to a bus 29.

The input device 24 receives an input of various kinds of information, such as operation information, from the administrator of the platform 2, for example. The monitor 25 displays various screens, such as a display screen, for the administrator of the platform 2, for example. For example, data generators such as a plurality of monitoring cameras (imaging apparatuses) are connected to the interface device 27.

The memory 22 is a storage memory including a read only memory (ROM) and a random access memory (RAM). Various software programs or data for the programs is written in the ROM of the memory 22. The software program on the memory 22 is appropriately read and executed by the processor 21. In addition, the RAM of the memory 22 is used as a primary storage memory or a working memory. In addition, the memory 22 stores a communication target registration table described later.

The storage 23 is a storage device, such as a hard disk drive (HDD), a solid state drive (SSD), and a storage class memory (SCM), and stores various kinds of data. The storage 23 stores various software programs.

The processor 21 controls the entire platform 2. The processor 21 may be a multiprocessor. The processor 21 (hardware processor) may be any one of, for example, a central processing unit (CPU), a micro processing unit (MPU), a graphics processing unit (GPU), a digital signal processor (DSP), an application specific integrated circuit (ASIC), a programmable logic device (PLD), and a field programmable gate array (FPGA). In addition, the processor 21 may be a combination of two or more types of elements among the CPU, the MPU, the GPU, the DSP, the ASIC, the PLD, and the FPGA.

In the platform 2, the processor 21 executes software programs stored in the memory 22 or the storage 23 to implement various functions. In particular, communication processing between the platforms 2 implemented by executing a dedicated software program by the processor 21 will be described in detail later.

In addition, the above-described various software programs do not necessarily need to be stored in the memory 22 or the storage 23. For example, the platform 2 may read and execute a program stored in a storage medium that can be read by the medium reader 26 of the platform 2. The storage medium that can be read by the platform 2 corresponds to, for example, a portable recording medium such as a CD-ROM, a DVD disc, and a universal serial bus (USB) memory, a semiconductor memory such as a flash memory, a hard disk drive, and the like. Alternatively, the information processing program may be stored in an apparatus connected to a public line, the Internet, a LAN, or the like, and the platform 2 may read and execute the information processing program therefrom.

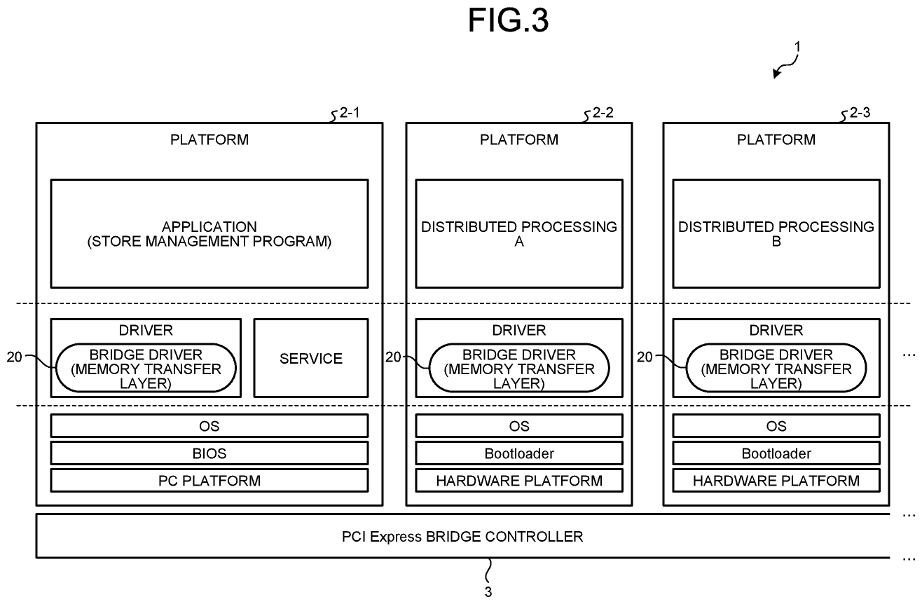

FIG. 3 is a diagram illustrating the software configuration of the platform 2 in the information processing system 1. In addition, in FIG. 3, only the software configuration of the platforms 2-1 to 2-3 is illustrated for the sake of convenience.

In the information processing system 1 illustrated in FIG. 3, the platform 2-1 is a general personal computer (PC) system, and Windows (registered trademark) is an operating system (OS). The platform 2-1 executes a store management program, which is an application, on the OS.

The platforms 2-2 and 2-3 are embedded systems, and use Linux (registered trademark) as an OS. The platforms 2-2 and 2-3 execute distributed processing programs (distributed processing A and B) on this OS.

Each platform 2 is provided with a bridge driver 20. The platform 2 communicates with the PCIe bridge controller 3 and another platform 2 through the bridge driver 20. In addition, the communication method of the bridge driver 20 will be described later.

Each platform 2 includes the processor 21 and a memory (physical memory) 22, and the processor 21 executes the OS, various programs, drivers, and the like stored in the memory 22 to implement each function.

The processor 21 provided in each platform 2 may be provided by different vendors. In the example illustrated in FIG. 1, a platform (for example, an x86 processor manufactured by Intel Corporation) having a plurality of RCs may be used as at least some of the platforms 2 (for example, the platform 2-7).

Each platform 2 is configured to be independently operable so as not to affect other driver configurations.

In the platform 2, part of the storage area of the memory 22 is used as a communication buffer 221 in which data transferred between the platforms 2 (between the processors 21) is temporarily stored.

In the address space that can be referred to by the processor 21 of the platform 2, a predetermined address range is provided to access slots (slots #0 to #7) described later (that is, this address range is divided according to the number of slots). Any address range obtained by dividing this address range is associated with a certain slot. For example, the address range represented by the slot #0 is associated with the platform 2-1 connected to the slot #0. In addition, the address range represented by the slot #4 is associated with the platform 2-5 connected to the slot #4. The processor 21 transfers transmission data for each slot by setting each address range as a destination.

### PCIe Bridge Controller

The PCIe bridge controller 3 implements communication of data between the plurality of platforms 2-1 to 2-8.

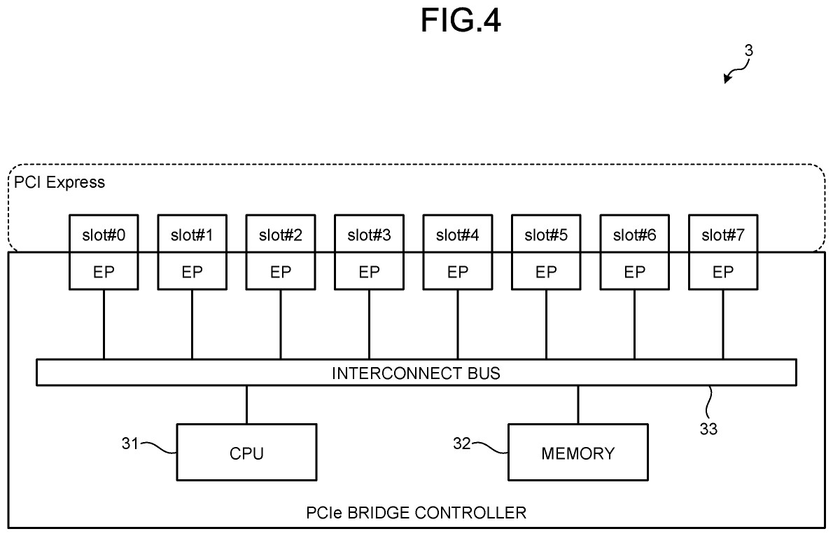

FIG. 4 is a diagram schematically illustrating the hardware configuration of the PCIe bridge controller 3 in the information processing system 1.

The PCIe bridge controller 3 is, for example, a relay device having EPs of eight channels in one chip. As illustrated in FIG. 4, the PCIe bridge controller 3 includes a CPU 31, a memory 32, an interconnect bus 33, and a plurality of (eight in the example illustrated in FIG. 4) slots. The respective slots are identified by slot numbers #0, #1, #2, #3, #4, #5, #6, and #7.

The slots #0 to #7 are connectors provided to be connected to the interconnect bus 33. A device configured to satisfy the PCIe standard is connected to each of the slots #0 to #7. In particular, in the information processing system 1, the platform 2 is connected to each of the slots #0 to #7. The platforms 2 connected to the slots #0 to #7 can communicate with each other through the interconnect bus 33. In the present embodiment, an example in which the slots #0 to #7 are illustrated as connection portions will be described. However, the connection portion is not limited to the slot, and may be any connection interface that enables connection with the platform 2.

In addition, as in the platforms 2-1 to 2-8, one processor 21 may be connected to one slot 34. However, the present disclosure is not limited thereto, and one platform 2 may be connected to a plurality of (for example, two) slots and various modifications can be made.

By assigning a plurality of slots to one platform 2, it is possible to cause the platform 2-7 to perform communication using a wide communication band.

Each of the slots #0 to #7 is connected to the interconnect bus 33 through an internal bus. The CPU 31 and the memory 32 are connected to the interconnect bus 33. As a result, the slots #0 to #7, the CPU 31, and the memory 32 are communicably connected to each other over the interconnect bus 33.

The memory 32 is, for example, a storage memory (physical memory) including a ROM and a RAM. In the ROM of the memory 32, a software program relevant to data communication control and data for the program are written. The software program on the memory 32 is appropriately read and executed by the CPU 31. In addition, the RAM of the memory 32 is used as a primary storage memory or a working memory.

In addition, the PCIe bridge controller 3 includes a register (not illustrated) corresponding to each slot. In the base address register (BAR) space of the register, a storage area is provided for each slot. That is, storage areas corresponding to the slots #0 to #7 are provided in the BAR space of the register.

The PCIe bridge controller 3 performs data transfer between the platforms 2 using a storage area for each slot in the BAR space.

The CPU 31 controls the entire PCIe bridge controller 3. The CPU 31 may be a multiprocessor. In addition, instead of the CPU 31, any one of the MPU, the GPU, the DSP, the ASIC, the PLD, and the FPGA may be used. In addition, the CPU 31 may be a combination of two or more types of elements among the CPU, the MPU, the GPU, the DSP, the ASIC, the PLD, and the FPGA.

Then, the CPU 31 executes a software program stored in the memory 32, thereby implementing data transfer between the platforms 2 (between the processors 21) in the PCIe bridge controller 3.

In order to speed up data transfer between the platforms 2, using the PCIe, the PCIe bridge controller 3 causes the processor provided in each platform 2 to operate as an RC as illustrated in FIG. 1, thereby implementing data transfer between the EPs that operate as devices.

Specifically, in the information processing system 1, the processor of each platform 2 is made to operate as a PCIe RC as a data transfer interface. In addition, for each platform 2 (processor 21), the PCIe bridge controller 3, that is, the slots #0 to #7 to which the respective platforms 2 are connected are made to operate as EPs.

As a method of connecting the PCIe bridge controller 3 to the processor 21 as an EP, various known methods can be used.

For example, at the time of connection with the platform 2, the PCIe bridge controller 3 notifies the processor 21 of a signal representing that the PCIe bridge controller 3 functions as an EP, so that the PCIe bridge controller 3 is connected to the processor 21 as an EP.

The PCIe bridge controller 3 transfers data to a plurality of RCs by tunneling the data by end point to end point (EP to EP). Communication between the processors 21 is logically connected when a PCIe transaction occurs, and data can be transferred in parallel between the processors 21 when data transfer does not concentrate on one processor 21.

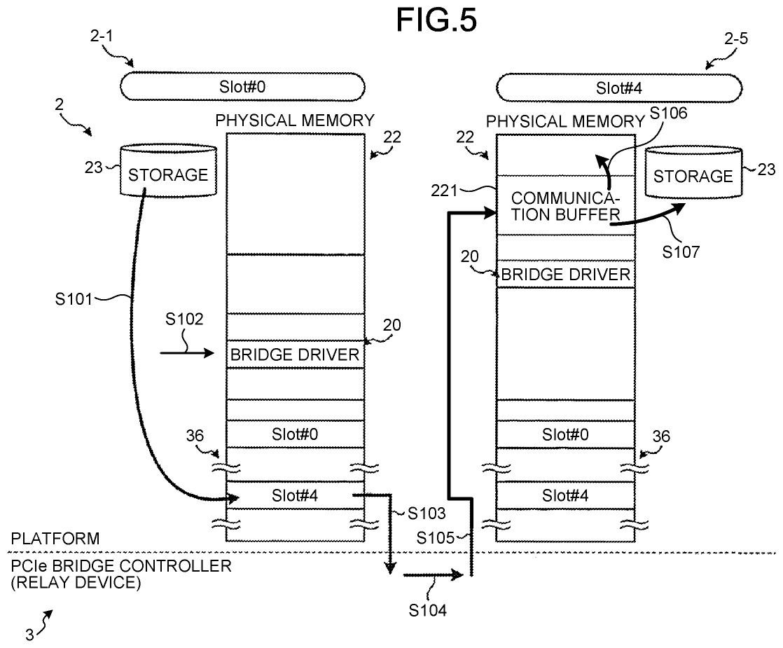

Next, a method for transferring data between the platforms 2 through the PCIe bridge controller 3 in the information processing system 1 will be described with reference to FIG. 5. FIG. 5 is a diagram for describing an example of a data transfer method between platforms via the PCIe bridge controller 3 (a relay device) in the information processing system 1 according to the present embodiment.

In the example illustrated in FIG. 5, a case will be described in which data is transferred from the platform 2-1 connected to the slot #0 to the platform 2-5 connected to the slot #4.

The platform 2-1, as a transmission source, stores data transmitted by software or the like (hereinafter, referred to as transmission data) in a memory area 36 of the platform 2-1 from the storage 23 or the like provided in the platform 2-1 (Step S101). The memory area 36 may be part of a communication buffer in which data to be transferred is temporarily stored. Each memory area 36 of the platform 2 is an area provided with the same size. The memory area 36 is divided according to the number of slots. The divided storage area of the memory area 36 is associated with one of the slots. For example, the storage area represented by the slot #0 in the memory area 36 is associated with the platform 2-1 connected to the slot #0, and the storage area represented by the slot #4 in the memory area 36 is associated with the platform 2-5 connected to the slot #4. The platform 2-1 stores the transmission data in an area (here, the slot #4), which is assigned to a slot as a transmission destination, in the memory area 36.

Based on the storage area of the memory area 36 of the platform 2, the platform 2-1 as a transmission source having a function as a root complex acquires or generates slot information representing the slot as a transmission destination and address information representing the address of the transmission destination in the divided area of the memory area 36 (Step S102).

The platform 2-1 as a transmission source transfers transfer data including the slot information, the address information, and the transmission data to the PCIe bridge controller 3 having functions of a plurality of end points (Step S103). Then, the PCIe bridge controller 3 transfers the transfer data to the platform 2-4 as a transmission destination by connecting the slot as a transmission source and the slot as a transmission destination to each other by EP to EP based on the slot information (Step S104). Based on the slot information and the address information, the platform 2 as a transmission destination stores the transmission data (or the transfer data) in the area represented by the address information in the storage area corresponding to the communication buffer 221 of the platform 2 as a transmission destination (Step S105).

In the platform 2-5 as a transmission destination, a program reads the transmission data stored in the communication buffer 221 and moves the read transmission data to another area of the memory (local memory) 22 or the storage 23 (Steps S106 and S107).

As described above, data (transfer data) is transferred from the platform 2-1 as a transmission source to the platform 2-5 as a transmission destination.

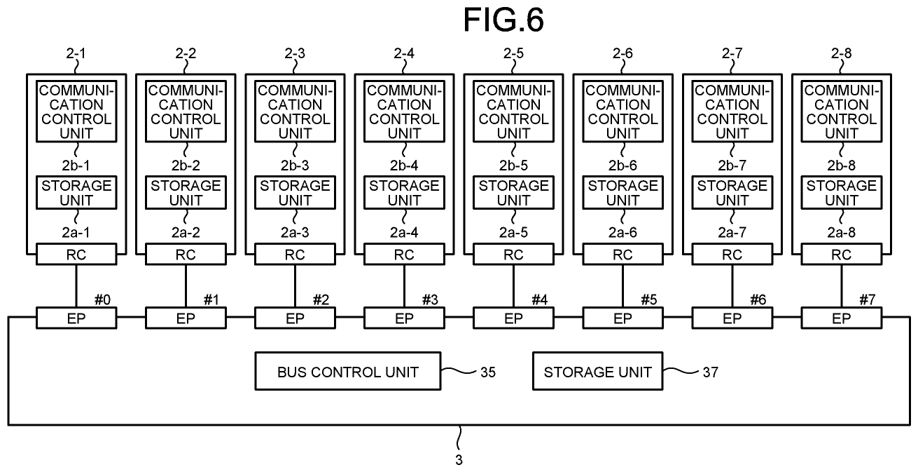

FIG. 6 is a block diagram illustrating functions of each platform 2 and the PCIe bridge controller 3. As illustrated in the diagram, the platforms 2-1, 2-2, 2-3, 2-4, 2-5, 2-6, 2-7, and 2-8 have storage units 2a-1, 2a-2, 2a-3, 2a-4, 2a-5, 2a-6, 2a-7, and 2a-8 and communication control units 2b-1, 2b-2, 2b-3, 2b-4, 2b-5, 2b-6, 2b-7, and 2b-8, respectively. The PCIe bridge controller 3 has a bus control unit 35 and a storage unit 37.

Hereinafter, as a code representing a storage unit, when it is necessary to specify one of a plurality of storage units, reference numerals “2a-1” to “2a-8” are used. On the other hand, reference numeral “2a” is used to indicate an arbitrary storage unit. Similarly for the communication control unit, when it is necessary to specify one of a plurality of communication control units of the platform 2, reference numerals “2b-1” to “2b-8” are used. On the other hand, reference numeral “2b” is used to indicate an arbitrary communication control unit.

The storage unit 2a includes the memory 22, the storage 23, and the like. The storage unit 2a has a memory area provided with the same size in each memory 22 of the platform 2.

In addition, the storage unit 2a stores a communication target registration table T as connection information representing whether each of the other platforms 2 is a communication target in units of connectors (for example, slots). Here, the communication target registration table T is a table that defines another platform 2, which is a communication target of each platform 2, by a slot number, and represents whether to communicate with the communication target in units of connectors. Each platform 2 does not communicate with platforms other than those registered in the communication target registration table T stored in its own storage unit 2a. That is, the communication target registration table T is information that regulates (restricts) a communication target (communication partner) of the corresponding platform. In the present embodiment, as an example of connection information, the communication target registration table T is shown. However, information representing whether each of the platforms 2 is a communication target in units of connectors (for example, slots) may be used.

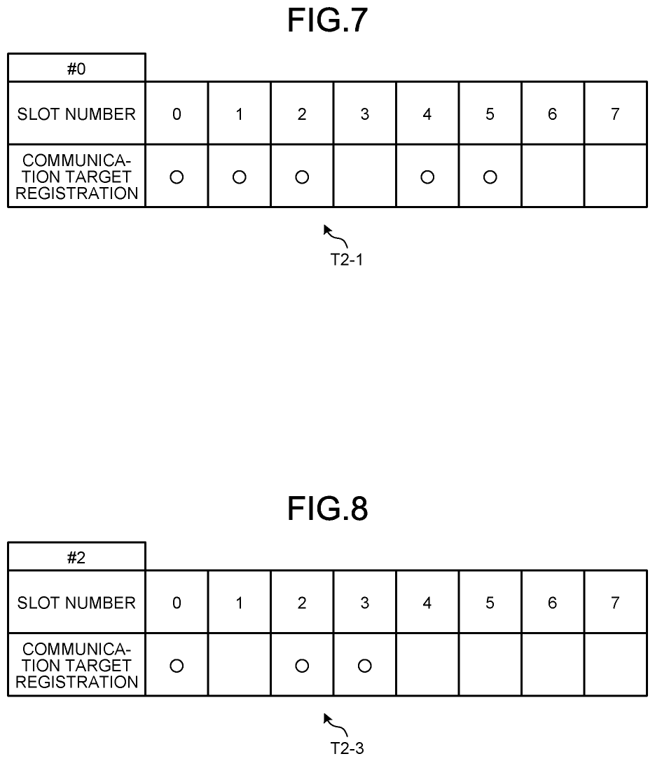

FIG. 7 is a diagram showing an example of a communication target registration table T2-1 stored in a storage unit 2a-1 of a platform 2-1 connected to a slot #0. As shown in the diagram, in the communication target registration table T2-1, which platform is the communication target of the platform 2-1 is registered by the slot number. In the example shown in the diagram, according to the communication target registration table T2-1, it is registered that each of the platform 2-1 (itself) connected to the slot #0, the platform 2-2 connected to the slot #1, the platform 2-3 connected to the slot #2, the platform 2-5 connected to the slot #4, and the platform 2-6 connected to the slot #5 is a communication target of the platform 2-1.

FIG. 8 is a diagram showing an example of a communication target registration table stored in the storage unit 2a-3 of the platform 2-3 connected to the slot #2. As shown in the diagram, in the communication target registration table T2-3, which platform is the communication target of the platform 2-3 is registered by the slot number. In the example shown in the diagram, according to the communication target registration table T2-3, it is registered that each of the platform 2-1 connected to the slot #0, the platform 2-3 connected to the slot #2, and the platform 2-4 connected to the slot #3 is a communication target of the platform 2-3 (itself).

In addition, FIGS. 7 and 8 illustrate cases in which the number of a slot, to which a platform itself is connected, is also registered in each communication target registration table T. However, these are merely examples, and the number of a slot to which a platform itself is connected may not be registered.

In addition, the content of the communication target registration table can be changed at an arbitrary timing by a rewriting operation from the input device 24.

Referring back to FIG. 6, the communication control unit 2b of the platform 2 performs communication with the PCIe bridge controller 3 and another platform 2. The communication control unit 2b is software implemented by the processor 21 by reading and executing software programs, which are stored in the memory 22 and the storage 23. The communication control unit 2b includes a function to work as the bridge driver 20.

When transmitting data to another platform, the communication control unit 2b acquires or generates slot information representing the slot as a transmission destination and address information, which represents the address of the transmission destination in the divided area of the memory area, based on the address range (corresponding to the transmission destination platform) of the memory area of the storage unit 2a. The communication control unit 2b transfers transfer data including the slot information, the address information, and the transmission data to the PCIe bridge controller 3. Therefore, the PCIe bridge controller 3 transfers the transmission data to another platform 2 as a transmission destination by connecting the slot as a transmission source and the slot as a transmission destination to each other by EP to EP based on the slot information.

When the transmission data is received, the communication control unit 2b stores the transmission data in the address range of the storage unit 2a corresponding to the slot number of the platform 2 as a transmission destination based on the slot information and the address information.

In addition, the communication control unit 2b reads the transfer data stored in the address range of the storage unit 2a and moves the read transmission data to the memory (local memory) 22 or the storage 23.

In the data communication between the platforms 2 described above, the communication control unit 2b communicates with a partner (platform as a communication target) registered in the communication target registration table T stored in the storage unit 2a. That is, the communication control unit 2b does not communicate with a platform other than the platforms registered in the communication target registration table T stored in the storage unit 2a in principle.

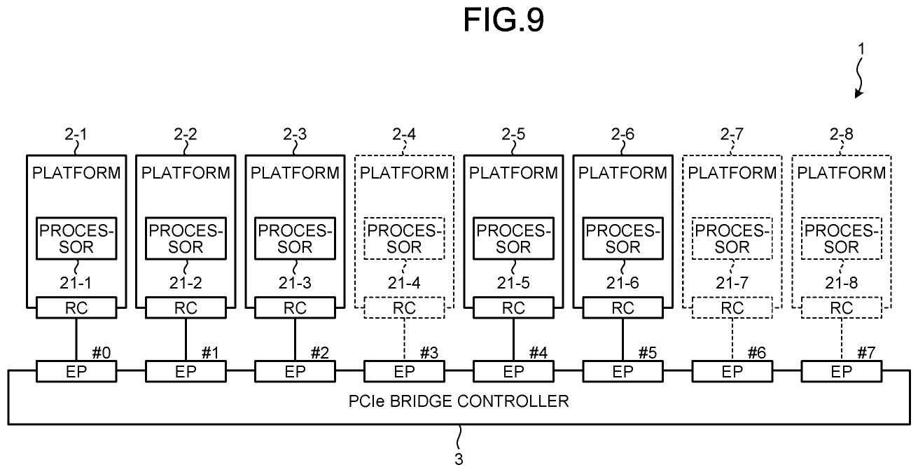

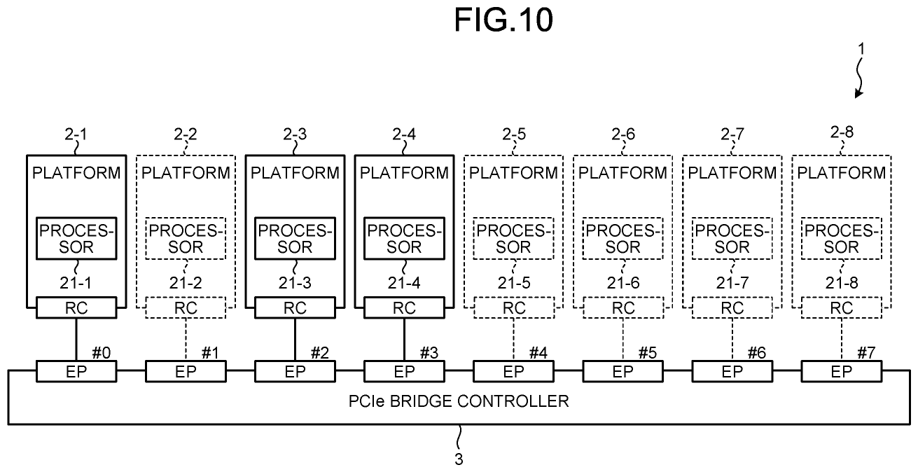

FIG. 9 is a diagram illustrating communication targets of the platform 2-1 regulated by the communication target registration table T2-1 shown in FIG. 7. As illustrated in the diagram, FIG. 10 is a diagram illustrating communication targets of the platform 2-3 regulated by the communication target registration table T2-3 shown in FIG. 8.

The slots #3, #6, and #7 are not registered in the communication target registration table T2-1. Therefore, as illustrated in FIG. 9, the platform 2-1 cannot communicate with the platforms 2-4, 2-7, and 2-8 corresponding to the slots #3, #6, and #7, respectively. In other words, from the viewpoint of the platform 2-1, the setting environment is that the platforms 2-4, 2-7, and 2-8 are not present as communication targets. Therefore, the platform 2-1 does not perform any data transmission and reception including communication check with respect to the platforms 2-4, 2-7, and 2-8.

Similarly, the slots #1, #4, #5, #6, and #7 are not registered in the communication target registration table T2-3. For this reason, as illustrated in FIG. 10, the platform 2-3 cannot communicate with the platforms 2-2, 2-5, 2-6, 2-7, and 2-8 corresponding to the slots #1, #4, #5, #6, and #7, respectively. In other words, from the viewpoint of the platform 2-3, the setting environment is that the platforms 2-2, 2-5, 2-6, 2-7, and 2-8 are not present as communication targets. Therefore, the platform 2-3 does not perform any data transmission and reception including communication check with respect to the platforms 2-2, 2-5, 2-6, 2-7, and 2-8.

That is, by restricting (regulating) the communication target of each platform by the communication target registration table T, it is possible to reduce the data traffic in the information processing system 1 according to the present embodiment. In particular, the regulation of the communication target by the communication target registration table T is very advantageous in terms of traffic reduction when broadcast communication or multicast communication is performed between the platforms 2.

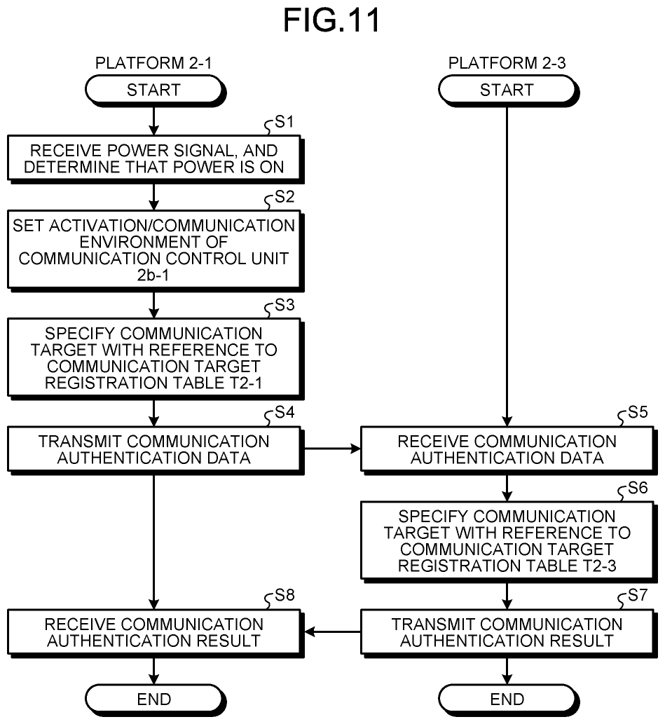

FIG. 11 is a flowchart for describing the flow of communication processing executed between the platform 2-1 and the platform 2-3 according to the communication target registration table T2-1 shown in FIG. 7 and the communication target registration table T2-3 shown in FIG. 8.

When the processor 21-1 of the platform 2-1 receives a power signal from the PCIe bridge controller 3 and determines that the power is ON (Step S1), the processor 21-1 reads a software program from the memory 22 or the storage 23, the communication control unit 2b-1 as the bridge driver 20 is activated, and the communication environment is set (Step S2).

The communication control unit 2b-1 specifies a communication target with reference to the communication target registration table T2-1 stored in the storage unit 2a-1 (Step S3). According to the example of the communication target registration table T2-1 shown in FIG. 7, communication targets of the platform 2-1 are restricted to the platform 2-1 (itself) corresponding to the slot #0, the platform 2-2 corresponding to the slot #1, the platform 2-3 corresponding to the slot #2, the platform 2-5 corresponding to the slot #4, and the platform 2-6 corresponding to the slot #5.

The communication control unit 2b-1 of the platform 2-1 transmits communication authentication data for checking communication to the platform 2-3 that is a communication target (Step S4).

The communication control unit 2b-3 of the platform 2-3 receives the communication authentication data transmitted from the communication control unit 2b-1 of the platform 2-1 (Step S5), and specifies a communication target with reference to the communication target registration table T2-3 (Step S6). The communication control unit 2b-3 of the platform 2-3 transmits a communication authentication result to the communication control unit 2b-1 (Step S7).

For example, in the case of the platform 2-3, according to the example of the communication target registration table T2-3 shown in FIG. 7, the platform 2-1 connected to the slot #0 is registered as a communication target. Therefore, the communication control unit 2b-3 of the platform 2-3 confirms that the platform 2-1 is its own communication target, and returns a result representing that the communication authentication is completed to the communication control unit 2b-1 of the platform 2-1. The communication control unit 2b-1 of the platform 2-1 receives the communication authentication result transmitted from the communication control unit 2b-3 of the platform 2-3 (Step S8). Thereafter, the platform 2-1 executes data communication with the platforms 2-2, 2-3, 2-5, and 2-6 as targets.

In addition, in the diagram, the case where the platform 2-3 has already been activated is illustrated. When the platform 2-3 receives a power signal from the PCIe bridge controller 3 and determines that the power is ON, the platform 2-3 executes substantially the same processing as in the case of the platform 2-1 illustrated in FIG. 11.

### Effect

As described above, the information processing system 1 according to the embodiment includes a plurality of information processing apparatuses, each of which includes the processor 21 and which include the platform 2-1 as a main information processing apparatus and the platforms 2-2 to 2-8 as a plurality of sub information processing apparatuses, and the PCIe bridge controller 3 as a relay device for relaying communication between the platforms 2-1 to 2-8 connected to each other through the slots #0 to #7 as a plurality of connectors provided on the interconnect bus 33. Each of the plurality of platforms 2 as a plurality of sub information processing apparatuses has the storage unit 2a that stores connection information (communication target registration table T), which represents whether the platform 2-1 as a main information processing apparatus or each of the plurality of platforms 2 as other sub information processing apparatuses is a communication target in units of slots, and the communication control unit 2b that communicates with at least one of the plurality of information processing apparatuses based on the connection information.

Therefore, according to the information processing system 1 of the embodiment, at least the platforms 2-2 to 2-8 as sub information processing apparatuses can regulate its own communication target (communication partner) using the communication target registration table T that defines a communication target using the numbers #0 to #7 of slots used for connection to the interconnect bus 33. As a result, according to the information processing system 1, it is possible to reduce the traffic by suppressing data communication including communication check for the platforms 2-2 to 2-8 as sub information processing apparatus that do not need to be communication targets. In addition, the information processing system 1 can improve the communication efficiency of the entire information processing system 1.

### Second Embodiment

Next, an information processing system according to a second embodiment will be described.

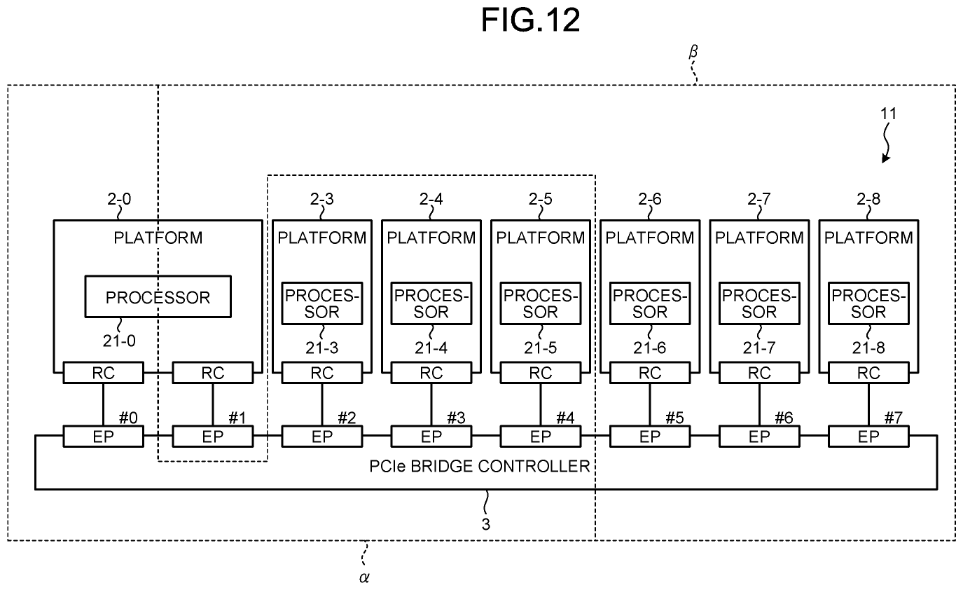

FIG. 12 is a diagram schematically illustrating the connection configuration of a plurality of platforms in an information processing system 11 according to the present embodiment. The difference between the information processing system 11 illustrated in FIG. 12 and the information processing system 11 illustrated in FIG. 1 is that the platform 2-0 as a main unit is connected to the PCIe bridge controller 3 through two RCs and two EPs (corresponding to slots #0 and #1). The hardware configuration of the platform 2-0 is the same as that in the example illustrated in FIG. 2.

In the information processing system 11, two systems of virtual LANs of a segment α corresponding to the slot #0 and a segment β corresponding to the slot #1 are formed to divide the bandwidth of the processor 21-1.

That is, as illustrated in FIG. 12, the platform 2-0 as a main information processing apparatus connected to the EP of slot #0 and the platform 2-3 connected to the EP of slot #2, the platform 2-4 connected to the EP of slot #3, and the platform 2-5 connected to the EP of slot #4, which are sub information processing apparatuses, are associated with each other to form an independent virtual LAN as the segment α.

In addition, the platform 2-0 as a main information processing apparatus connected to the EP of slot #1 and the platform 2-6 connected to the EP of slot #5, the platform 2-7 connected to the EP of slot #6, and the platform 2-8 connected to the EP of slot #7, which are sub information processing apparatuses, are associated with each other to form an independent virtual LAN as the segment β.

The information processing system according to the present embodiment regulates the communication target (communication partner) using the communication target registration table T when segmentation is performed by such two systems of virtual LANs. Hereinafter, a case where a communication target of the platform 2-0 belonging to the segment α is regulated will be described as an example.

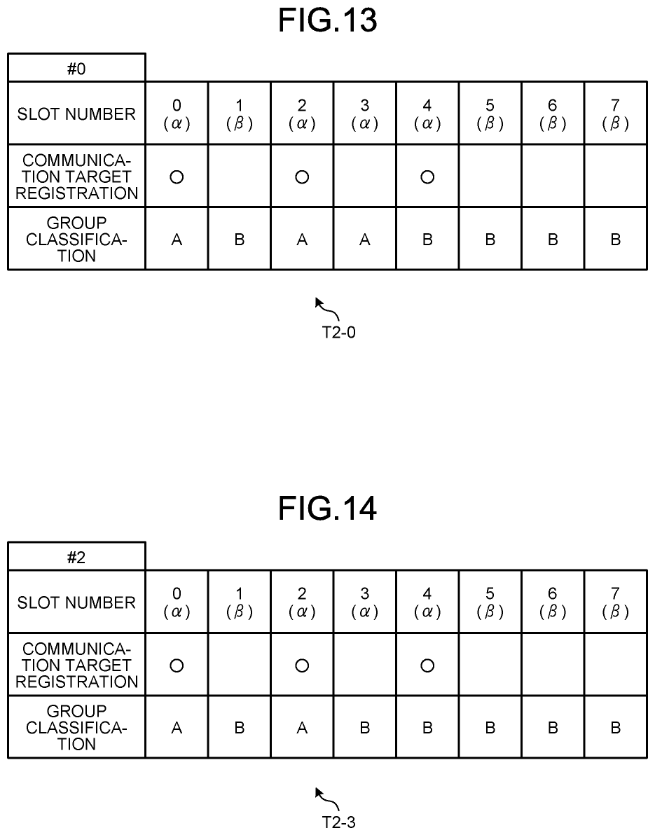

FIG. 13 is a diagram showing an example of a communication target registration table T2-0 stored in a storage unit 2a-0 of a platform 2-0 connected to the slot #0. As shown in the diagram, in the communication target registration table T2-0, which platform is the communication target of the platform 2-0 is registered by the slot number. In the example shown in the diagram, according to the communication target registration table T2-0, it is registered that each of the platform 2-0 (itself) connected to the slot #0, the platform 2-3 connected to the slot #2, the platform 2-5 connected to the slot #4, and the platform 2-6 connected to the slot #5 is a communication target of the platform 2-0.

In addition, in the communication target registration table T2-0 shown in FIG. 13, group classification is performed for each slot number. Here, the group classification is an item for classifying the segment into a plurality of subdivided virtual LANs. FIG. 13 shows an example in which the segment α to which the platform 2-0 belongs is classified into two of group A and group B.

That is, the platform 2-0 connected to the slot #0 communicates only with the platform 2-3 as a communication target of a subdivided virtual LAN α-A among the platforms 2-3, 2-4, and 2-5 belonging to the segment α. In addition, the platform 2-0 connected to the slot #0 communicates only with the platform 2-5 as a communication target of a subdivided virtual LAN α-B among the platforms 2-3, 2-4, and 2-5 belonging to the segment α.

FIG. 14 is a diagram showing an example of the communication target registration table T2-3 stored in the storage unit 2a-3 of the platform 2-3 connected to the slot #2. As shown in the diagram, in the communication target registration table T2-3, which platform is the communication target of the platform 2-3 is registered by the slot number. In the example shown in the diagram, according to the communication target registration table T2-3, it is registered that each of the platform 2-0 connected to the slot #0, the platform 2-3 (itself) connected to the slot #2, and the platform 2-5 connected to the slot #4 is a communication target of the platform 2-3.

In addition, as in the example of FIG. 13, in the communication target registration table T2-3 shown in FIG. 14, group classification is performed for each slot number. That is, the platform 2-3 connected to the slot #2 communicates only with the platform 2-0 as a communication target of the subdivided virtual LAN α-A among the platforms 2-0, 2-4, and 2-5 belonging to the segment α.

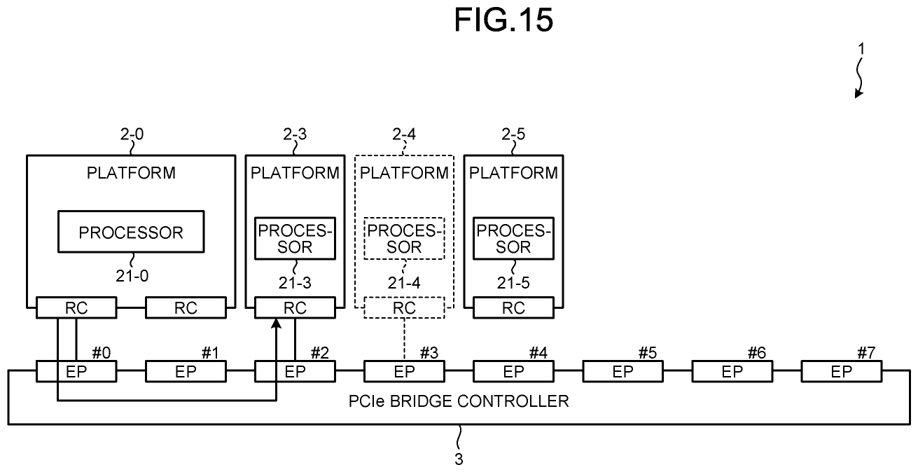

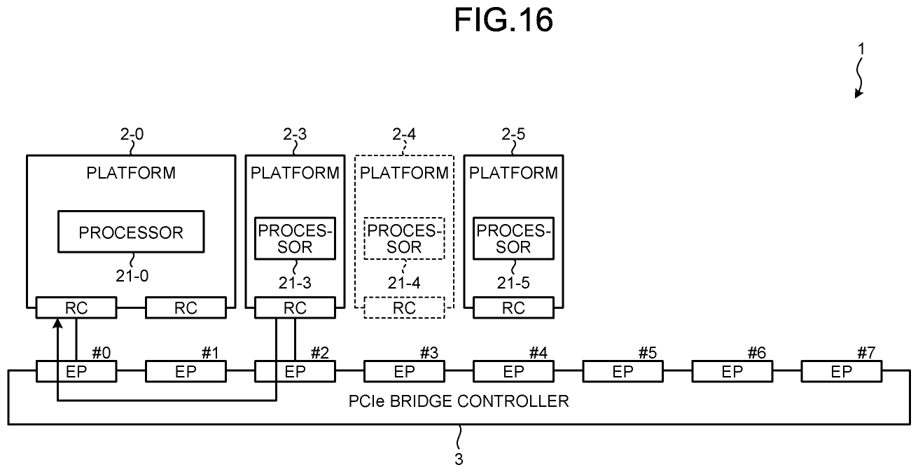

FIG. 15 is a diagram illustrating communication targets belonging to the segment α of the platform 2-0 regulated by the communication target registration table T2-0 shown in FIG. 14. FIG. 16 is a diagram illustrating communication targets belonging to the segment α of the platform 2-3 regulated by the communication target registration table T2-3 shown in FIG. 14. In addition, in FIGS. 15 and 16, only the platforms 2-0, 2-3, 2-4, and 2-5 belonging to the segment α are described. In addition, in each of the communication target registration tables T2-0 and T2-3, the platform 2 registered as a communication target is represented by a solid line, and the platform 2 that is not registered as a communication target is represented by a dotted line. In addition, for the platform 2 belonging to the group A, the route complex (RC) and the end point (EP) are connected to each other by a solid line or a dotted line, and for the platform 2 not belonging to the group A (that is, belonging to the group B), the route complex (RC) and the end point (EP) are not connected to each other by a line.

In the communication target registration table T2-0, the slot #3 among the slot numbers belonging to the segment α is not registered. Therefore, as illustrated in FIG. 15, the platform 2-4 corresponding to the slot #3 cannot be a communication target of the platform 2-0 (In addition, the platform 2 corresponding to the slot belonging to the segment β is not originally a communication target of the platform 2-0 due to segmentation). In other words, from the viewpoint of the platform 2-0, the setting environment is that the platform 2-4 is not present as a communication target. Therefore, the slot #0 of the platform 2-0 does not perform any data transmission and reception including communication check with respect to the platforms 2-4, 2-6, 2-7, and 2-8.

Similarly, in the communication target registration table T2-3, the slots #0 and #2 among the slot numbers belonging to the segment α are classified into group A and registered as communication targets. Therefore, as illustrated in FIG. 16, the platform 2-4 corresponding to the slot #3 cannot be a communication target of the platform 2-3 (In addition, the platform 2 corresponding to the slot belonging to the segment β is not originally a communication target of the platform 2-3 due to segmentation). Therefore, the platform 2-3 does not perform any data transmission and reception including communication check with respect to the platforms 2-4, 2-6, 2-7, and 2-8.

In addition, in the information processing system according to the present embodiment, for example, communication processing executed by the platform 2-0 with respect to the platform 2-3 according to the communication target registration table T2-0 is substantially the same as that described with reference to FIG. 11.

As described above, according to the information processing system 11 according to the embodiment, the platform 2 as each information processing apparatus regulates a communication target (communication partner) to the platform 2 corresponding to the group and the slot registered in the communication target registration table T. Therefore, since there is no need to perform communication authentication for the platform 2 that does not need to be a communication target, wasteful data communication can be eliminated. As a result, the communication efficiency of the entire information processing system 11 can be improved.

In addition, in the present embodiment, the case has been exemplified in which, in the information processing system 11 having two segments α and β, a communication target is regulated by the communication target registration table T using group classification and slot classification for each of the segments α and β. However, the present disclosure is not limited to this example. For example, even in the non-segmented information processing system 1 described in the first embodiment, a communication target can be regulated by the communication target registration table T using group classification and slot classification. In this case, a plurality of virtual LANs classified by groups are substantially the same as a plurality of virtual LANs classified by segmentation.

In addition, in the present embodiment, an information processing system having two segments α and β has been described as an example. However, the number of segments is merely an example, and the configuration of the present embodiment can be applied to an information processing system having three or more segments.

### Effect

According to the information processing system 11 of the present embodiment, in addition to the effect of the information processing system 1 of the first embodiment, it is easy for the administrator to grasp the correspondence since communication targets are regulated in units of the segments α and β. Thus, according to the information processing system 11, the work load of the administrator can be reduced.

### Third Embodiment

Next, an information processing system according to a third embodiment of the present disclosure will be described. In the information processing system 1 according to the first embodiment or the information processing system 1 according to the second embodiment, depending on the content of the communication target registration table, the platform 2-1 or the platform 2-0 as a main information processing apparatus may not be able to communicate with another platform 2 as a sub information processing apparatus.

In such a case, the platform 2 that is not a communication target cannot be recognized on the virtual LAN, and the network settings cannot be reconstructed.

In such a situation, the information processing system according to the present embodiment implements a fail-safe mechanism for forcibly making the platform 2-1 or the platform 2-0 as a main information processing apparatus communicable with another platform 2 as a sub information processing apparatus. In addition, a case in which a fail-safe mechanism is implemented in the information processing system 1 according to the first embodiment will be described as an example below. However, also in the information processing system 11 according to the second embodiment, the fail-safe mechanism can be implemented by a similar configuration. Therefore, the description of the fail-safe mechanism in the information processing system 11 according to the second embodiment will be omitted.

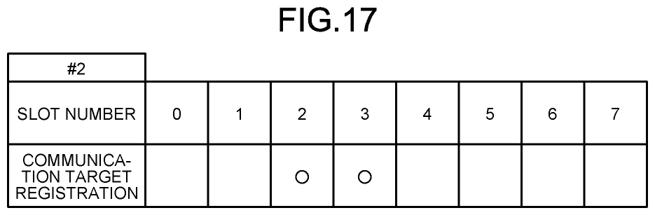

FIG. 17 is a diagram showing an example of the communication target registration table T2-3 stored in the storage unit 2a-3 of the platform 2-3 connected to the slot #2 in the information processing system 1 illustrated in FIG. 1. As shown in the diagram, in the communication target registration table T2-3, the platform 2-1 as a main information processing apparatus is not registered as a communication target. Therefore, the platform 2-3 cannot communicate with the platform 2-1.

In such a case, the processor 21-3 of the platform 2-3 performs determination as a setting error state since the platform 2-1 is not registered as a communication target in the communication target registration table T2-3. The processor 21-3 of the platform 2-3 forcibly sets at least the processor 21-1 of the platform 2-1 as a communication target regardless of the current content of the communication target registration table T2-3 (fail-safe mechanism).

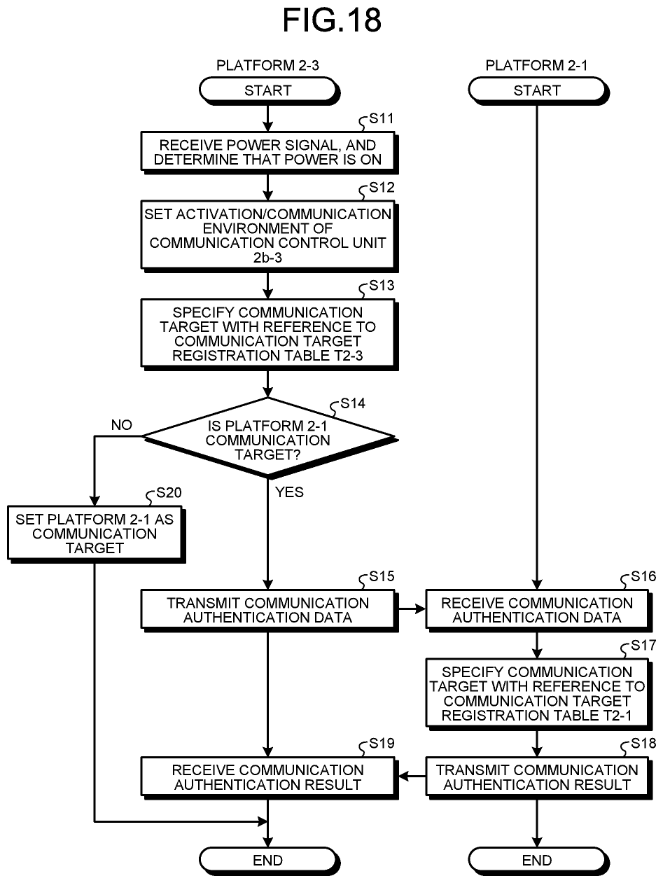

FIG. 18 is a flowchart for describing the flow of communication processing executed between the platform 2-3 and the platform 2-1 according to the communication target registration table T2-1 shown in FIG. 7 and the communication target registration table T2-3 shown in FIG. 17.

In the diagram, since processing of Steps S11 to S13 is the same as the processing of Steps S1 to S3 illustrated in FIG. 11, the description thereof will be omitted.

The communication control unit 2b-3 determines whether the platform 2-1 as a main information processing apparatus is a communication target based on the communication target specified in Step S13 (Step S14). When the platform 2-1 is a communication target (Yes in Step S14), the same processing as in Steps S4, S5, S6, S7, and S8 illustrated in FIG. 11 is performed in Steps S15, S16, S17, S18, and S19, respectively. Thereafter, the platform 2-3 executes data communication with the platform 2-1 as a target.

On the other hand, when the platform 2-1 as a main information processing apparatus is not a communication target (No in Step S14), the communication control unit 2b-3 changes the setting so that the platform 2-1 becomes a communication target regardless of the current content of the communication target registration table T2-3 (Step S20).

As described above, according to the information processing system according to the present embodiment, when there are the platforms 2-2 to 2-8 as sub information processing apparatuses for which the platform 2-1 as a main information processing apparatus is not set as a communication target, a setting change for setting at least the platform 2-1 as a communication target is forcibly executed. Therefore, it is possible to avoid setting that the platforms 2-2 to 2-8 are not communication targets of the platform 2-1. As a result, for example, even in the case of a setting in which the platforms 2-2 to 2-8 cannot communicate with the platform 2-1 according to the communication target registration table T, an environment in which a network can be reconstructed can be forcibly provided. The user can correctly reset the communication environment including the communication target registration table T for the platforms 2-2 to 2-8 forcibly set as communication targets of the platform 2-1.

### Effect

According to the information processing systems 1 and 11 of the present embodiment, the platform 2-1 can be set as a communication target regardless of the current content of the communication target registration table T2-3. Therefore, for example, even if the setting of the communication target registration table T2-3 is incorrect, the administrator can correct the communication target registration table T2-3 by performing communication from the platform 2-1. As a result, the work load of the administrator can be reduced.

In the embodiments described above, the PCIe has been described as an example of the I/O interface of each unit, but the interface is not limited to the PCIe. For example, the interface of each unit may be any technology that enables data transfer between a device (peripheral controller) and a processor through a bus, such as an interconnect bus for transferring data. The (data transfer) bus may be a general-purpose bus that can transfer data at high speed in a local environment (for example, one system or one device) provided in one housing or the like. The interface may be any of a parallel interface and a serial interface.

In the case of serial transfer, the I/O interface may have a configuration that allows a point-to-point connection so that data can be transferred on a packet basis. In addition, in the case of serial transfer, the I/O interface may have a plurality of lanes. The layer structure of the I/O interface may have a transaction layer for generating and decoding a packet, a data link layer for performing error detection and the like, and a physical layer for performing conversion between serial and parallel. In addition, the I/O interface may include a root complex having one or more ports at the top of the hierarchy, an end point that is an I/O device, a switch for increasing the number of ports, a bridge for converting a protocol, and the like. The interface may multiplex data to be transmitted and a clock signal with a multiplexer and transmit the multiplexed data. In this case, the reception side may separate the data and the clock signal from each other using a demultiplexer.

What is claimed is:

1. An information processing system comprising:
a plurality of information processing apparatuses that includes a main information processing apparatus and a plurality of sub information processing apparatuses, each of the plurality of information processing apparatuses being provided with a memory and a hardware processor; and
a relay device that relays communication between the plurality of information processing apparatuses connected to each other over a plurality of connectors provided on a bus, wherein,
in each of the plurality of sub information processing apparatuses,
the memory stores connection information representing whether the main information processing apparatus or each of the other sub information processing apparatuses is a communication target of the corresponding sub information processing apparatus in units of the connectors; and
the hardware processor communicates with at least one of the plurality of information processing apparatuses based on the connection information.

2. The information processing system according to claim 1, wherein
the memory stores the connection information representing whether the main information processing apparatus or each of the other sub information processing apparatuses is a communication target in units of the connectors and groups for classifying the plurality of sub information processing apparatuses, and
the hardware processor communicates with at least one of the plurality of information processing apparatuses based on the connection information represented in units of the connectors and the groups for classifying the plurality of sub information processing apparatuses.

3. The information processing system according to claim 1, wherein, in the information processing apparatus,
the memory stores the connection information representing whether each of the plurality of information processing apparatuses is a communication target in units of the connectors, and
the hardware processor
communicates with at least one of the plurality of sub information processing apparatuses based on the connection information, and
sets the main information processing apparatus as a communication target when the main information processing apparatus is not set as a communication target in the connection information.

4. An information processing system comprising:
a plurality of information processing apparatuses that includes a main information processing apparatus and a plurality of sub information processing apparatuses, each of the plurality of information processing apparatuses being provided with a memory and a hardware processor; and
a relay device that relays communication between the plurality of information processing apparatuses connected to each other over a plurality of connectors provided on a bus, wherein
the plurality of connectors are classified into connectors belonging to a first segment and connectors belonging to a second segment,
the main information processing apparatus is connected to one of the connectors belonging to the first segment and one of the connectors belonging to the second segment,
first sub information processing apparatuses among the plurality of sub information processing apparatuses are connected to remaining connectors belonging to the first segment,
second sub information processing apparatuses among the plurality of sub information processing apparatuses are connected to remaining connectors belonging to the second segment,
at least one of the plurality of first sub information processing apparatuses includes
a first memory that stores connection information representing whether the main information processing apparatus or each of the other plurality of first sub information processing apparatuses is a communication target in units of the connectors, and
a first hardware processor that communicates with the main information processing apparatus or at least one of the plurality of first sub information processing apparatuses based on the connection information, and
at least one of the plurality of second sub information processing apparatuses includes
a second memory that stores connection information representing whether the main information processing apparatus or each of the other plurality of second sub information processing apparatuses is a communication target in units of the connectors, and
a second hardware processor that communicates with the main information processing apparatus or at least one of the plurality of second sub information processing apparatuses based on the connection information.

5. The information processing system according to claim 4, wherein
the first memory stores the connection information representing whether the main information processing apparatus or each of the other plurality of first sub information processing apparatuses is a communication target in units of the connectors and groups for classifying the plurality of first sub information processing apparatuses,
the first hardware processor communicates with at least one of the plurality of first information processing apparatuses based on the connection information represented in units of the connectors and the groups for classifying the plurality of first sub information processing apparatuses,
the second memory stores the connection information representing whether the main information processing apparatus or each of the other plurality of second sub information processing apparatuses is a communication target in units of the connectors and groups for classifying the plurality of first sub information processing apparatuses, and
the second hardware processor communicates with at least one of the plurality of second information processing apparatuses based on the connection information represented in units of the connectors and the groups for classifying the plurality of second sub information processing apparatuses.

6. The information processing system according to claim 4, wherein, in the information processing apparatus,
the memory stores the connection information representing whether each of the plurality of information processing apparatuses is a communication target in units of the connectors, and
the hardware processor
communicates with each connector of the main information processing apparatus based on the connection information, and
sets all connectors of the main information processing apparatus as communication targets when at least one connector of the plurality of main information processing apparatuses is not set as a communication target in the connection information.
